(19) United States
(12) Patent Application Publication
(10) Pub. No.: US 2022/0329122 A1
(43) Pub. Date: Oct. 13, 2022

(54) ELECTRIC MACHINE HAVING A RESERVOIR FOR COOLANT LEAKAGE

(71) Applicant: Valeo Siemens eAutomotive Germany GmbH, Erlangen (DE)

(72) Inventors: Andreas Dietz, Bad Neustadt a.d.Saale (DE); Philipp Holzheimer, Bad Neustadt a.d.Saale (DE)

(73) Assignee: Valeo Siemens eAutomotive Germany GmbH, Erlangen (DE)

(21) Appl. No.: 17/657,232

(22) Filed: Mar. 30, 2022

(30) Foreign Application Priority Data
Mar. 31, 2021 (DE) 10 2021 203 304.0

(51) Int. Cl. H02K 1/32; H02K 7/00; H02K 5/20

(52) U.S. Cl. CPC H02K 1/32; H02K 7/006; H02K 5/203

(57) ABSTRACT

An electric machine (1), comprising a housing (2), in which a stator (3) and a rotor (4), which is rotatable relative to the stator (3), are accommodated, a cooling device with a cooling channel (5) through which a coolant can flow and which extends from an inlet (7), through the housing (2) and through the rotor (4), to an outlet (6), and a sealing device (21) for sealing off the rotor (4) with respect to an interior space (22) of the housing, wherein a reservoir (12) for coolant leakage that occurs during a rotation of the rotor (4) is formed between the sealing device (21) and the housing (2). Additionally described are a drivetrain and a vehicle (17) having such an electric machine (1), and a method for operating the electric machine (1).

The invention relates to an electric machine, comprising a housing, in which a stator and a rotor, which is rotatable relative to the stator, are accommodated, a cooling device with a cooling channel through which a coolant can flow and which extends from an inlet, through the housing and through the rotor, to an outlet, and a sealing device for sealing off the rotor with respect to an interior space of the housing.

Electric machines of this type are increasingly used in electrically driven vehicles or hybrid vehicles. Here, the electric machine is used predominantly as an electric motor for driving a wheel or an axle of the vehicle. The electric motor may be configured, inter alia, as a synchronous motor or an asynchronous motor.

The electric motor is normally mechanically coupled to a gearbox for rotational speed adaptation. The electric motor is additionally normally connected to an inverter which, from DC voltage that is provided from a battery, generates AC voltage, in particular multi-phase AC voltage, for the operation of the electric machine.

It is also possible for the electric machine to be operated as a generator for the recuperation of kinetic energy of a vehicle, wherein the kinetic energy is converted firstly into electrical energy and then into chemical energy of the battery.

The rotor of the electric machine normally has a rotor shaft that is enclosed by a cylindrical rotor body. Aside from a stack of laminated metal sheets, the rotor body may have, inter alia, permanent magnets or a winding with an electrical conductor.

Owing to the heat that is generated during the operation of the electric machine, the electric machine has a cooling device for dissipating the heat, which cooling device comprises a cooling channel through which a liquid coolant can flow. The cooling channel extends from an inlet, through the housing of the electric machine and onward through the rotor, to an outlet which is formed in the housing. The coolant, which is for example a water-glycol mixture, is conveyed in a circuit.

A sealing device seals off the rotor with respect to the housing, for example in an axial direction and a radial direction of the rotor. In particular, the coolant-filled cooling channel that runs through the rotor is sealed off with respect to an interior space of the housing, such that no coolant can pass from the cooling channel into the interior space and lead to damage there, for example as a result of corrosion. The interior space may accommodate, inter alia, the stator, and may otherwise be filled with air.

The temperature-induced change in volume of the air in the interior of the housing necessitates the provision of aeration and/or ventilation that prevents the generation of a negative pressure or of a positive pressure in the housing. For this purpose, a ventilation channel may be provided which extends from the sealing device to an opening of the housing.

It has been found that, despite the sealing device, an at least small amount of technical leakage of coolant can occur via the sealing device during the operation of the electric machine. This technical leakage (coolant leakage) occurs in particular when the electric machine is operated in a particular direction of rotation. In the case of an electrically driven vehicle, the leakage can occur for example during reverse travel.

To resolve this problem, it has already been proposed to collect the technical leakage in a separate reservoir, that is to say in a vessel provided for this purpose. This vessel must however be emptied at certain time intervals during the course of the maintenance of the vehicle.

It is the object of the invention to specify an electric machine that can be operated with less outlay.

To achieve said object, in the case of an electric machine of the type mentioned in the introduction, it is provided according to the invention that a reservoir for coolant leakage that occurs during a rotation of the rotor is formed between the sealing device and the housing.

The invention is based on the recognition that a separate vessel for collecting coolant leakage can be omitted by virtue of this function being performed by a reservoir that is formed between the sealing device and the housing. This firstly saves structural space, but far more importantly, emptying of the coolant leakage during the course of the maintenance of the vehicle can be omitted. The electric machine according to the invention can thus be operated without maintenance, resulting in a cost saving.

The sealing device is preferably configured to seal off the rotor in a radial direction and an axial direction. This prevents coolant from escaping from the cooling channel and passing, for example, into a bearing of the rotor shaft. The sealing in a radial direction may be implemented by means of a radial shaft sealing ring. The sealing in an axial direction may be implemented by means of a mechanical hybrid seal, for example with a slip ring seal.

Furthermore, the electric machine according to the invention may be configured such that the coolant leakage occurs during a rotation of the rotor in a first direction of rotation as a result of a small volume of the coolant passing the sealing device. The small volume of coolant thus escapes from the coolant circuit and collects as leakage in the housing of the electric machine.

Owing to the construction of the sealing device, the coolant leakage occurs only during a rotation of the rotor in the first direction of rotation. In the case of a vehicle that is driven using the electric machine, the first direction of rotation may be assigned to reverse travel of the vehicle. The coolant leakage collects under the action of gravitational force in the lower region of a cavity, the reservoir, which is arranged between the sealing device and the housing. The reservoir may be formed in particular as a lower region of a free space that surrounds the sealing device.

In the electric machine according to the invention, it may particularly advantageously be provided that the coolant leakage is conveyed out of the reservoir again during a rotation of the rotor in a second direction of rotation that is opposite to the first direction of rotation. This means that the reservoir filled with coolant leakage is emptied in self-acting fashion during forward travel of the vehicle.

Emptying of the coolant leakage from the reservoir thus occurs automatically when the vehicle moves forward. It is significant here that the coolant leakage is supplied via the sealing device back to the cooling circuit. The coolant leakage therefore does not need to be collected in a separate vessel, nor can it pass into the environment.

A refinement of the invention provides that the rotor, or a component of the sealing device that is rotatable with the rotor, has a surface structure that causes the coolant leakage to be conveyed out of the reservoir. The reservoir can thus be particularly easily regulated. The surface structure may in particular be such that the liquid coolant that has collected in the reservoir is conveyed out of the reservoir, and returned into the cooling channel, during the rotation of the rotor in the second direction of rotation.

The rotatable component may for this purpose be configured as a ring, provided with a surface structure, of a slip ring seal, in particular as a ring of the abovementioned slip ring seal for the sealing of the rotor in an axial direction. The surface structure may be engraved on the ring, for example by means of a laser.

Such a ring is described in EP3190317A1 and may have spiral-shaped grooves by means of which coolant can be pumped from the reservoir back into the cooling channel. The ring may additionally have so-called Rayleigh steps that improve the sliding capability of the slip ring seal.

The sealing device may furthermore have a radial shaft sealing ring that delimits the reservoir for the coolant leakage. The reservoir thus extends between the radial shaft seal and the inner side of the housing of the electric machine.

The above-stated objective is furthermore achieved by means of a drivetrain for a vehicle, which drivetrain has an electric machine according to the invention. The drivetrain may additionally have a gearbox coupled to the electric machine and/or an inverter connected to the machine, by means of which inverter a multi-phase AC voltage required for the operation of the electric machine can be provided.

The object is furthermore achieved by means of a vehicle that has a drivetrain of said type.

The invention additionally relates to a method for operating an electric machine, having a housing, in which a stator and a rotor, which is rotatable relative to the stator, are accommodated, having a cooling device, having a cooling channel through which a coolant can flow and which extends from an inlet, through the housing and through the rotor, to an outlet, and having a sealing device for sealing off the rotor with respect to an interior space of the housing.

The method according to the invention is distinguished by the fact that a reservoir for coolant leakage that occurs during a rotation of the rotor in a first direction of rotation is formed between the sealing device and the housing, wherein the coolant leakage is conveyed out of the reservoir again during a rotation of the rotor in a second direction of rotation that is opposite to the first direction of rotation.

The advantages and details discussed in conjunction with the description of the electric machine self-evidently also apply analogously to the method according to the invention.

The invention will be discussed below on the basis of an exemplary embodiment with reference to the figures. The figures are schematic illustrations in which:

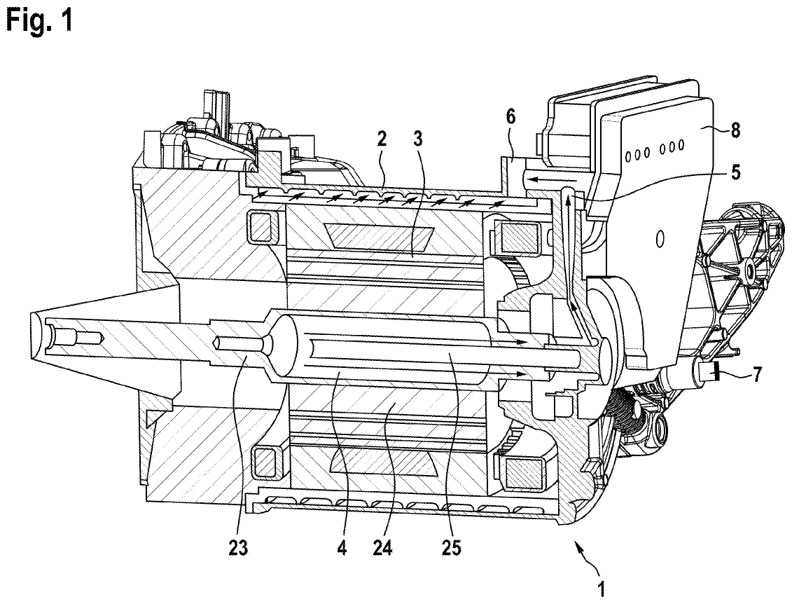

FIG. 1 shows a perspective sectional view of an electric machine according to the invention;

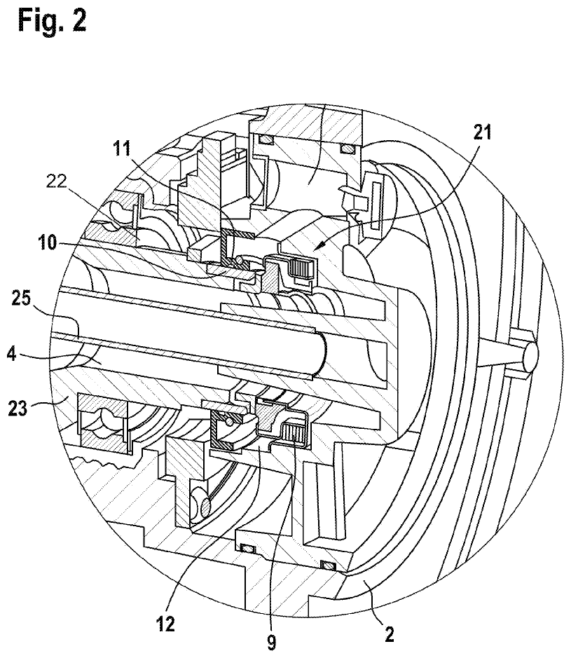

FIG. 2 shows an enlarged view of the right-hand end of the rotor in FIG. 1;

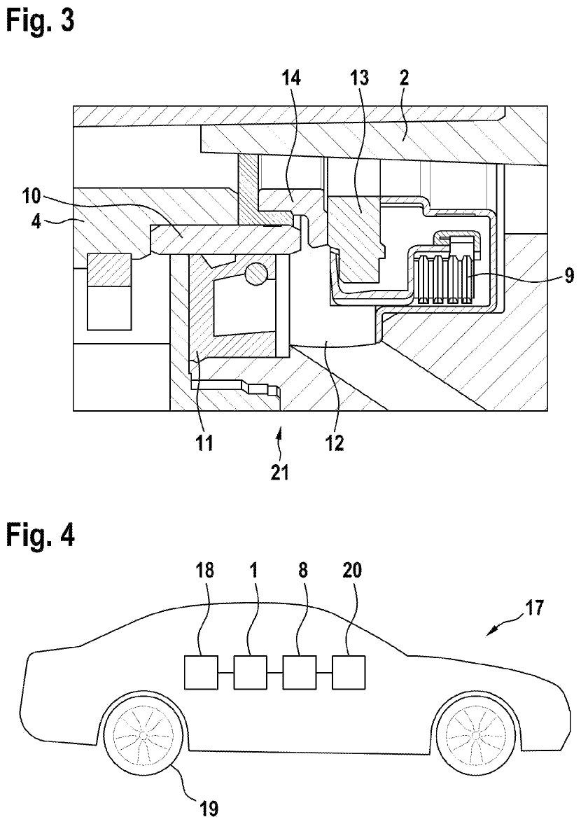

FIG. 3 shows a detail of the sealing device; and

FIG. 4 shows a vehicle according to the invention.

The electric machine 1 shown in a perspective sectional view in FIG. 1 belongs to the drivetrain of a vehicle.

The electric machine 1 comprises a housing 2, in which a stator 3 and a rotor 4, which is rotatable relative to the stator 3 and which has a rotor shaft 23, are accommodated. The rotor shaft 23 is enclosed by a cylindrical rotor body 24. The electric machine 1 furthermore comprises a cooling device with a cooling channel 5 through which a coolant can flow and which extends from an inlet 7, through the housing 2, to an outlet 6.

The inlet 7 and the outlet 6 are connected via coolant lines (not illustrated) to a pump, such that the coolant is conveyed in a circuit. The coolant dissipates heat that is generated during the operation of the electric machine 1.

It can be seen in FIG. 1 that the cooling channel 5 extends through the housing 2 proceeding from the inlet 7. The coolant flows through a cooling pipe 25 into the hollow rotor shaft 23 of the rotor 4. At the end of the cooling pipe 25, the flow direction of the coolant is reversed, following which the coolant flows out of the rotor shaft 23 past a sealing device 21 (see FIG. 2) and passes onward to the outlet 6.

On the outside of the housing 2, there is arranged an inverter 8 that provides the AC voltage required for the operation of the electric machine 1.

FIG. 2 shows a sectional view of the right-hand end of the rotor shaft 23 shown in FIG. 1. The sealing device 21 serves for sealing off the rotor shaft 23 in a radial direction and an axial direction with respect to the housing 2. In particular, the sealing device 21 serves for sealing off the rotor shaft 23 with respect to an interior space 22 of the housing 2, in which the stator 3 is accommodated. The sealing prevents coolant from passing into the interior space 22 and leading to corrosion of the windings of the stator 3 therein.

The sealing device 21 comprises a slip ring seal 9 and a radial shaft sealing ring 11. The slip ring seal 9 is arranged in an axial direction between the free end (on the right in FIG. 2) of the rotor shaft 23 and a section of the housing 2. The slip ring seal 9 seals off the rotor shaft 23 axially.

Said end of the rotor shaft 23 is enclosed by a sleeve 10 composed of hardened high-grade steel. The sleeve 10 is in turn enclosed by the radial shaft sealing ring 11, which seals off the rotor shaft 23 radially with respect to the interior space 22 of the housing 2.

The sealing device 21 has the property that, in a particular direction of rotation of the electric machine, which is assigned to reverse travel of the electrically driven vehicle, the abovementioned technical leakage occurs. Said technical leakage however involves only a small volume, in the range of a few millilitres.

In the sectional view of FIG. 2 and in the enlarged view of FIG. 3, which shows a detail of the sealing device 21, it can be seen that an encircling free space is formed between the slip ring seal 9, the radial shaft sealing ring 11 and that section in the interior of the housing 2 which surrounds the seals. Said free space, more specifically its lower region in the installed state of the electric machine 1, serves as a reservoir 12 for the coolant leakage. If the technical leakage occurs as a result of the operation of the electric machine 1, in particular during reverse travel, said leakage collects in the reservoir 12.

In the event of a reversal of the direction of rotation, said coolant leakage is supplied back to the coolant circuit via the sealing device 21. The reservoir 12 is thus emptied again if the rotor 4 is rotated in the second direction of rotation that is opposite to the first direction of rotation.

The slip ring seal 9 comprises a static seal 13 and a ring 14 which is rotatable with the rotor shaft 23 and which has a special surface structure. In particular, the slip ring seal 9 may be configured as a mechanical hybrid seal.

The coolant leakage that has collected in the reservoir 12 is conveyed or conducted back into the coolant circuit again via the sealing device 21 by means of the surface structure of the ring 14.

Thus, in the method for operating the electric machine 1, coolant leakage that occurs during a rotation of the rotor 4 in the first direction of rotation is collected in the reservoir 12, and said leakage is conveyed out of the reservoir 12 again during a rotation of the rotor 4 in a second direction of rotation that is opposite to the first direction of rotation.

FIG. 4 shows a vehicle 17 with a drivetrain that comprises the electric machine 1. The electric machine 1 is coupled via a gearbox 18 to a wheel 19 of the vehicle 17. The electric machine 1 is additionally connected to the inverter 8. The energy stored in a battery 20 is converted by the inverter 8 into an AC voltage for the operation of the electric machine 1.

### LIST OF REFERENCE DESIGNATIONS

1 Electric machine
2 Housing
3 Stator
4 Rotor
5 Cooling channel
6 Outlet
7 Inlet
8 Inverter
9 Slip ring seal
10 Sleeve
11 Radial shaft sealing ring
12 Reservoir
13 Static ring
14 Rotatable ring
17 Vehicle
18 Gearbox
19 Wheel
20 Battery
21 Sealing device
22 Interior space
23 Rotor shaft
24 Rotor body
25 Cooling pipe

1. An electric machine, comprising:
a housing, in which a stator and a rotor, which is rotatable relative to the stator, are accommodated;
a cooling device with a cooling channel through which a coolant can flow and which extends from an inlet, through the housing and through the rotor, to an outlet; and
a sealing device for sealing off the rotor with respect to an interior space of the housing,
wherein a reservoir for coolant leakage that occurs during a rotation of the rotor is formed between the sealing device and the housing.

2. The electric machine according to claim 1, wherein the sealing device is configured to seal off the rotor in a radial direction and an axial direction.

3. The electric machine according to claim 1, wherein the electric machine is configured such that the coolant leakage occurs during a rotation of the rotor in a first direction of rotation, and said coolant leakage is conveyed out of the reservoir again during a rotation of the rotor in a second direction of rotation that is opposite to the first direction of rotation.

4. The electric machine according to claim 3, wherein the electric machine is configured such that the coolant leakage is returned into the cooling channel during the rotation of the rotor in the second direction of rotation.

5. The electric machine according to claim 3, wherein the rotor, or a component of the sealing device that is rotatable with the rotor, has a surface structure that causes the coolant leakage to be conveyed out of the reservoir.

6. The electric machine according to claim 5, wherein the rotatable component is configured as a ring of a slip ring seal.

7. The electric machine according claim 1, wherein the sealing device comprises a radial shaft sealing ring that delimits the reservoir for the coolant leakage.

8. A drivetrain for a vehicle, which has an electric machine according to claim 1.

9. A vehicle having a drivetrain according to claim 8.

10. A method for operating an electric machine, having a housing, in which a stator and a rotor, which is rotatable relative to the stator, are accommodated, having a cooling device with a cooling channel through which a coolant can flow and which extends from an inlet, through the housing and through the rotor, to an outlet, and having a sealing device for sealing off the rotor with respect to an interior space of the housing, the method comprising:
during a rotation of the rotor in a first direction of rotation, forming a reservoir for coolant leakage between the sealing device and the housing; and
conveying the coolant leakage out of the reservoir again during a rotation of the rotor in a second direction of rotation that is opposite to the first direction of rotation.
